(19) United States
(12) Patent Application Publication
(10) Pub. No.: US 2015/0269480 A1
(43) Pub. Date: Sep. 24, 2015

(54) IMPLEMENTING A NEURAL-NETWORK PROCESSOR

(71) Applicant: QUALCOMM Incorporated, San Diego, CA (US)

(72) Inventors: Jeffrey Alexander LEVIN, San Diego, CA (US); Erik Christopher MALONE, San Diego, CA (US); Edward Hanyu LIAO, San Diego, CA (US)

(21) Appl. No.: 14/300,019

(22) Filed: Jun. 9, 2014

Related U.S. Application Data
(60) Provisional application No. 61/968,440, filed on Mar. 21, 2014.

(51) Int. Cl. G06N 3/08

(52) U.S. Cl. CPC G06N 3/08

(57) ABSTRACT

Certain aspects of the present disclosure support a method and apparatus for implementing kortex neural network processor within an artificial nervous system. According to certain aspects, a plurality of spike events can be generated by a plurality of neuron unit processors of the artificial nervous system, and the spike events can be sent from a subset of the neuron unit processors to another subset of the neuron unit processors via a plurality of synaptic connection processors of the artificial nervous system.

### CLAIM OF PRIORITY UNDER 35 U.S.C. §119

This application claims benefit of U.S. Provisional Patent Application Serial No. 61/968,440, filed Mar. 21, 2014 and entitled “Method and Apparatus for Implementing Kortex Neural-Network Processor”, incorporated by reference in its entirety.

### BACKGROUND

1. Field

Certain aspects of the present disclosure generally relate to artificial nervous systems and, more particularly, to a method and apparatus for implementing kortex neural network processor.

2. Background

An artificial neural network, which may comprise an interconnected group of artificial neurons (i.e., neural processing units), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure provide a method for operating an artificial nervous system. The method generally includes generating, by a plurality of neuron unit processors of the artificial nervous system, a plurality of spike events, and sending the spike events from a subset of the neuron unit processors to another subset of the neuron unit processors via a plurality of synaptic connection processors of the artificial nervous system.

Certain aspects of the present disclosure provide an apparatus for operating an artificial nervous system. The apparatus generally includes a plurality of neuron unit processors of the artificial nervous system configured to generate a plurality of spike events, and a first circuit configured to send the spike events from a subset of the neuron unit processors to another subset of the neuron unit processors via a plurality of synaptic connection processors of the artificial nervous system.

Certain aspects of the present disclosure provide an apparatus for operating an artificial nervous system. The apparatus generally includes means for generating, by a plurality of neuron unit processors of the artificial nervous system, a plurality of spike events, and means for sending the spike events from a subset of the neuron unit processors to another subset of the neuron unit processors via a plurality of synaptic connection processors of the artificial nervous system.

Certain aspects of the present disclosure provide a computer-readable medium for operating an artificial nervous system. The computer-readable medium comprises instructions executable by a computer stored thereon for generating, by a plurality of neuron unit processors of the artificial nervous system, a plurality of spike events, and sending the spike events from a subset of the neuron unit processors to another subset of the neuron unit processors via a plurality of synaptic connection processors of the artificial nervous system.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons, in accordance with certain aspects of the present disclosure.

FIG. 2 illustrates an example processing unit (neuron) of a computational network (neural system or neural network), in accordance with certain aspects of the present disclosure.

FIG. 3 illustrates an example spike-timing dependent plasticity (STDP) curve, in accordance with certain aspects of the present disclosure.

FIG. 4 is an example graph of state for an artificial neuron, illustrating a positive regime and a negative regime for defining behavior of the neuron, in accordance with certain aspects of the present disclosure.

FIG. 5 illustrates examples of synapse class types and units that can drive synapses and spikes, in accordance with certain aspects of the present disclosure.

FIG. 6 illustrates an example diagram of spike-timing dependent plasticity (STDP) updates to plastic synapses, in accordance with certain aspects of the present disclosure.

FIG. 7 illustrates a flow diagram of example operations for operating an artificial nervous system, in accordance with certain aspects of the present disclosure.

FIG. 7A illustrates example means capable of performing the operations shown in FIG. 7.

FIG. 8 illustrates an example implementation for operating an artificial nervous system using a general-purpose processor, in accordance with certain aspects of the present disclosure.

FIG. 9 illustrates an example implementation for operating an artificial nervous system where a memory may be interfaced with individual distributed processing units, in accordance with certain aspects of the present disclosure.

FIG. 10 illustrates an example implementation for operating an artificial nervous system based on distributed memories and distributed processing units, in accordance with certain aspects of the present disclosure.

FIG. 11 illustrates an example implementation of a neural network in accordance with certain aspects of the present disclosure.

FIG. 12 illustrates an example hardware implementation of an artificial nervous system, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System

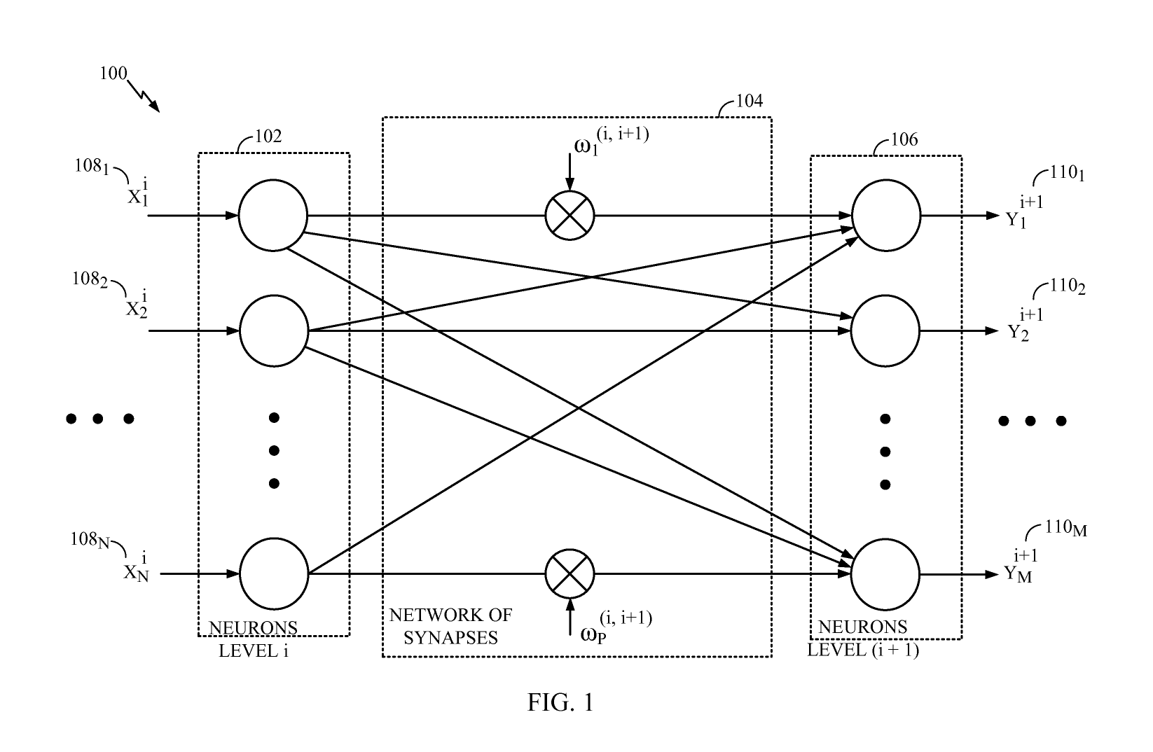

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input (e.g., an input current) to the level 102 neuron. Such inputs may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all-or nothing nerve impulse, having an amplitude of roughly 100 mV and a duration of about 1 ms. In a particular aspect of a neural system having a series of connected neurons (e.g., the transfer of spikes from one level of neurons to another in FIG. 1), every action potential has basically the same amplitude and duration, and thus, the information in the signal is represented only by the frequency and number of spikes (or the time of spikes), not by the amplitude. The information carried by an action potential is determined by the spike, the neuron that spiked, and the time of the spike relative to one or more other spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104). For certain aspects, these signals may be scaled according to adjustable synaptic weights w₁^{(i,i+1)}, . . . , w_{P}^{(i,i+1)} (where P is a total number of synaptic connections between the neurons of levels 102 and 106). For other aspects, the synapses 104 may not apply any synaptic weights. Further, the (scaled) signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example, due to its dynamics or feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and the like. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

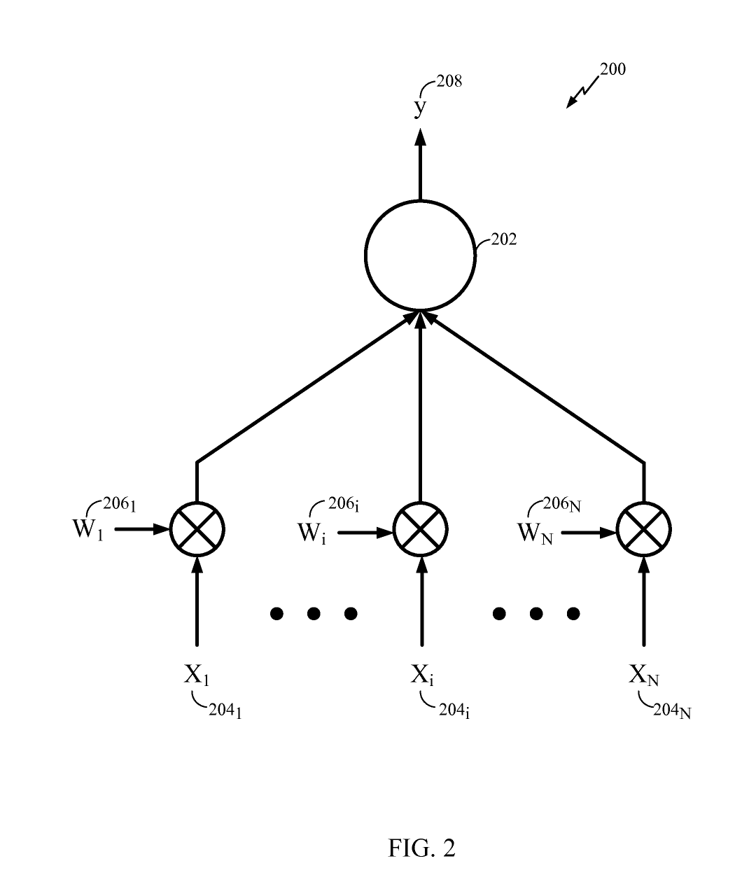

FIG. 2 illustrates an example 200 of a processing unit (e.g., an artificial neuron 202) of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 2061-206_{N} (w₁-W_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron 202) may be emulated by an electrical circuit, and its input and output connections may be emulated by wires with synaptic circuits. The processing unit, its input and output connections may also be emulated by a software code. The processing unit may also be emulated by an electric circuit, whereas its input and output connections may be emulated by a software code. In an aspect, the processing unit in the computational network may comprise an analog electrical circuit. In another aspect, the processing unit may comprise a digital electrical circuit. In yet another aspect, the processing unit may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate in together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synaptic delay may change only when a weight change occurs or if weights reach zero, but not if the weights are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as to computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity, and homeostatic plasticity.

STDP is a learning process that adjusts the strength of synaptic connections between neurons, such as those in the brain. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. In contrast, long-term depression (LTD) may occur if an input spike tends, on average, to occur immediately after an output spike. Then, that particular input is made somewhat weaker, hence the name “spike-timing-dependent plasticity.” Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period (i.e., being sufficiently cumulative to cause the output,), the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , t > 0 \\ {a}_{-} {e}^{t / {k}_{-}} , t < 0 ,\end{matrix} \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

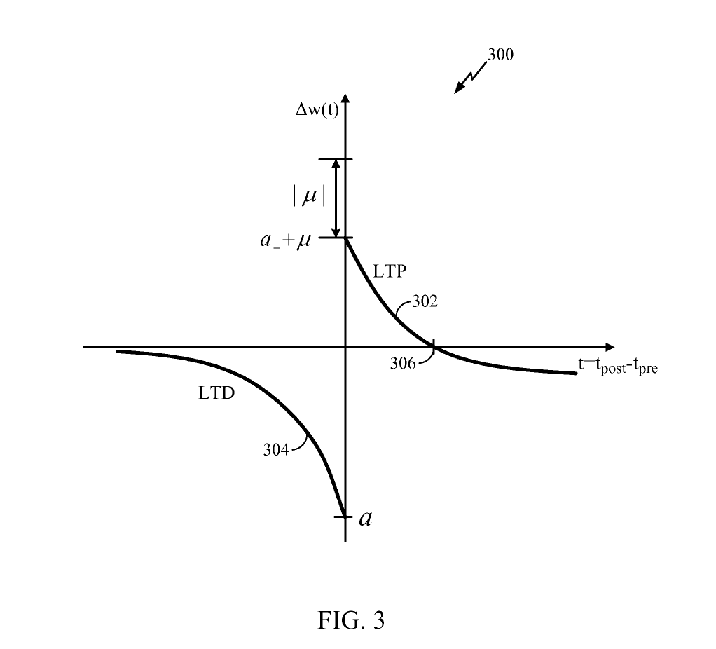

FIG. 3 illustrates an example graph 300 of a synaptic weight change as a function of relative timing of pre-synaptic and post-synaptic spikes in accordance with STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i-1 (presynaptic layer). In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n } ( t )}{d t} = α {v}_{n} ( t ) + β {\sum }_{m}^{ } {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

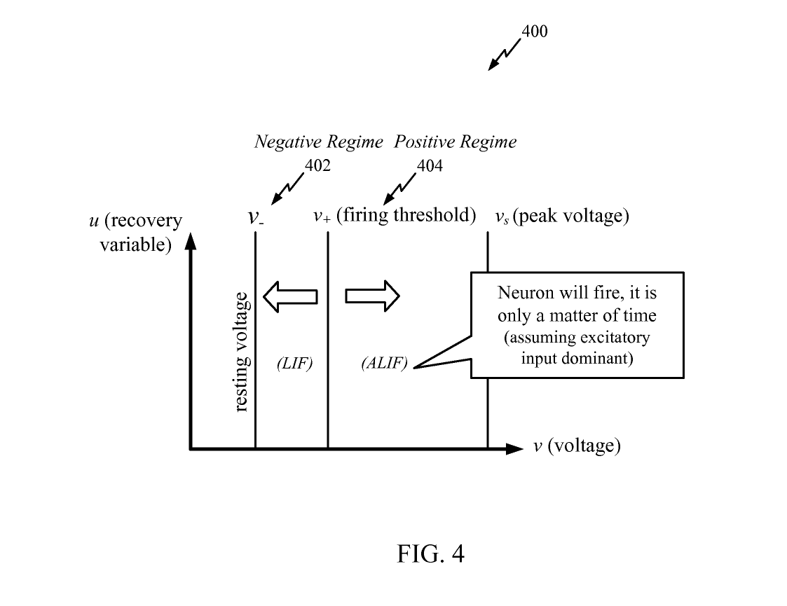

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model is defined to spike when the voltage v reaches a value vₛ. Subsequently, the state is typically reset at a reset event (which technically may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed-form solution is possible not only for state (and with a single exponential term), but also for the time required to reach a particular state. The closed-form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{\frac{Δ t}{{τ}_{u}}} - r & ( 12 )\end{matrix}$$

Therefore, the model state may be updated only upon events, such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is

$$Δ {t}_{s} = \{ \begin{matrix}{τ}_{+} log \frac{ {v}_{s} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Neural Coding

A useful neural network model, such as one composed of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

### Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

### Inputs

An input to a neuron model may include Dirac delta functions, such as inputs as currents, or conductance-based inputs. In the latter case, the contribution to a neuron state may be continuous or state-dependent.

There is a need in the art for efficient simulation of large neural networks, such as the neural network 100 from FIG. 1. In particular, there is a need for designing machines capable of supporting large spiking neural networks with a rich set of neuron models and synapse models. Further, it is desirable to support large synaptic fan-outs. Software simulators exist in the prior art, but their “inner loop” functions for updating neural and synapse states and for applying synaptic events are all implemented using many instruction cycles on the target processor, which is a bottleneck. Another bottleneck is fetching and processing of a vast number of synaptic connections that need to be performed efficiently, i.e., with high speed.

### Kortex Neural-Network Processor

Certain aspects of the present disclosure support implementation of a machine with many parallel “neuron unit” processors that can send spike events to each other via “synaptic connection” processors. The neuron unit processor may produce “spike events”. The synaptic connection processors may convert spike events into neuron unit inputs or “post-synaptic potential (PSP) weights”. These neuron unit processors may generate both “intrinsic” spike events (that stay within the machine) and “extrinsic” spike events (that leave the machine). In an aspect of the present disclosure, the neuron unit processor can accept inputs from synaptic connection processors and from “extrinsic” inputs.

An efficient mechanism is presented in this disclosure whereby groups of synapses all driven by the same spiking unit are processed together, to gain efficient access to a memory subsystem. The presented mechanism can support read/update/writeback processing of synaptic values so that “synaptic plasticity” can be effected. The writeback of new synaptic state values can occur after a spiking event or after a spike-replay event. In general, the neuron unit processors and synaptic connection processors presented in this disclosure can process a neuron update or synaptic event with a throughput of one update/event per clock cycle.

In accordance with certain aspects of the present disclosure, there are multiple neuron unit processors and multiple synaptic connection processors within a system. This can provide a great deal of parallelism and overall processing bandwidth. In an aspect of the present disclosure, each neuron unit processor can be described as a programmable machine in which each individual neuron instance has its own dedicated instruction and state memory word using a defined number of bits, e.g., #NST bits. This bit-width can be fixed or variable, wherein various partitions between instruction bits (fixed) and state bits (updated over time) can be designed.

When the entire op-code is held within the #NST bits, there is a “utility neuron” that can be programmed entirely independently from all other neurons in the system. When more instruction bits are desired, some of the #NST bits can be used as a pointer into shared table values, and portions of the instruction bits can be shared across multiple neurons. This may allow for a much larger and richer instruction set and can allow more of the #NST bits to be allocated to state information.

The synaptic connection processors can also be described as programmable machines in which each individual synaptic instance has its own dedicated instruction and state memory using a defined number of bits, e.g., #SST bits. Again, the bit-width can be fixed or variable, and various partitions between instruction bits and state bits can be designed. In addition, the shared table values can be used to extend the instruction set and to provide more update-able state bits.

The machine presented in this disclosure may also comprise special “neuromodulator” or “global signal” control blocks that can provide control parameters and values to the neuron unit and synaptic connection processors. Op-codes in those processors would be able to use various control values provided by the neuromodulator blocks. Inputs to the neuromodulator blocks can be provided by the same synaptic connection fabric that drives all of other intrinsic synapses.

According to certain aspects of the present disclosure, the synaptic and neural processors can be described in High Level Network Description (HLND) code, at a “base class” or “lower level class” layer. Generally, “user-friendly” interfaces can be provided by derived HLND classes built on top of the hardware-precise lower layer code. By doing this, it can be possible to isolate various less-significant hardware and low-level code changes from the user code, and to allow designs written for the user code to be mapped to many different hardware targets.

### Kortex HLND Overview

In accordance with certain aspects of the present disclosure, neural and synapse models implemented by the aforementioned Kortex hardware core can be described within a set of HLND files. Contents of these files can define unit and synapse base classes that closely match the hardware operation. HLND files can be provided, for example, with each hardware release and can be verified to match the hardware operation. In general, these files may change with each release as implementation details, bit-widths, etc. are updated.

According to certain aspects of the present disclosure, unit and synapse models can be controlled via parameter values. Interface variables and code sections of the hardware classes cannot be modified without diverging from the hardware release. The use of derived classes may help clarify the neural and synaptic models offered by hardware, and may provide a more stable interface than direct use of the base hardware class files. In an aspect of the present disclosure, multiple levels of derived classes may be utilized.

### Kortex Class Types

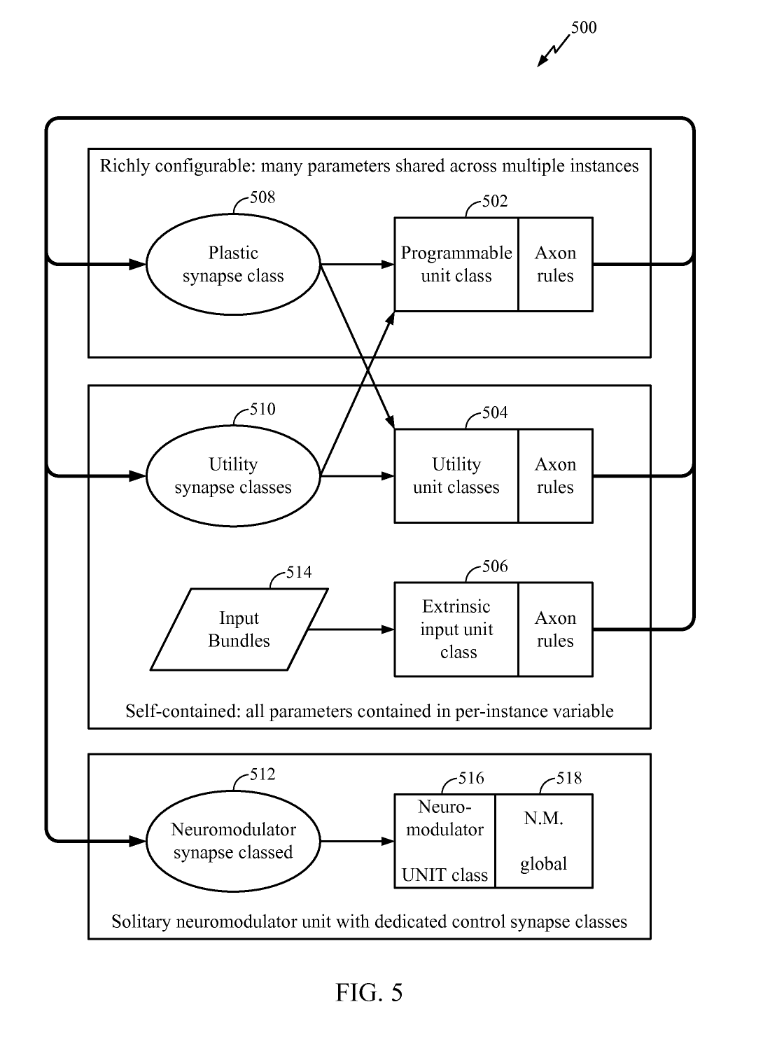

FIG. 5 illustrates examples 500 of synapse class types and units that can drive synapses/spikes, in accordance with certain aspects of the present disclosure. As illustrated in FIG. 5, there are three sorts of units that can drive spikes/synapses: programmable neurons (units) 502, utility neuron types (units) 504, and extrinsic (input spike) repeaters (units) 506. As also illustrated in FIG. 5, there are three sorts of synapses that can be driven from spiking units: a class of plastic synapses 508, a class of utility synapses 510, and a class of neuromodulator synapses 512.

The plastic synapse class 508 may comprise synapses that are richly configurable with many parameters shared across multiple instances. As illustrated in FIG. 5, the plastic synapses 508 may be driven by the programmable units 502, the utility units 504 and/or extrinsic input units 506. The plastic synapses 508 may drive the programmable units 502 and/or the utility units 504.

The utility synapse class 510 may comprise synapses that are self-contained, i.e., all parameters may be contained in per-instance variables. As illustrated in FIG. 5, the utility synapses 510 may be driven by programmable units 502, the utility units 504 and/or extrinsic input units 506. The utility synapses 510 may drive the programmable units 502 and/or the utility units 504. In an aspect, input bundles 514 may drive the extrinsic input units 506, as illustrated in FIG. 5.

In an aspect of the present disclosure, special neuromodulator unit(s) may provide the distribution of global neuromodulator values used by other classes (dopamine, norepinephrine, acetylcholine, etc). As illustrated in FIG. 5, a solitary neuromodulator unit 516 with global values 518 may be associated with dedicated control synapse classes, e.g., the neuromodulator synapse classes 512 driven by the programmable units 502, the utility units 504 and/or extrinsic input units 506.

### Utility (“Diagnostic”) Neuron Classes

In accordance with certain aspects of the present disclosure, the utility neuron classes represent a set of neural models that have very few control parameters. In an aspect, these control parameters can be stored in the state memory unique to each neural instance and do not have to be compiled into shared tables. Each utility neuron can utilize, for example, up to two input channels. According to certain aspects of the present disclosure, utility neuron classes may include periodic spiking, random spiking (e.g., Bernoulli trials), spike-on-input, delayed spike-on-input, and spike response model.

### Programmable (“RP”) Neuron Class

In accordance with certain aspects of the present disclosure, the programmable neuron class may comprise a rich parameter set requiring a lot of memory and can be implemented in hardware via indexed reference to shared tables. Unlike utility neuron classes, the total number of independently tuned programmable neurons would be limited by the hardware, e.g., to many hundreds.

In an aspect of the present disclosure, inputs may be current-based or conductance-based, with programmable filters per input channel. Further, neuromodulator options and homeostasis options can be available.

According to certain aspects of the present disclosure, rich programmability of (U,V) responses can be exploited. In an aspect, either two or four input channels can be utilized. Further, certain aspects of the present disclosure provide support for Izhikevich neuron model and Cold neuron model.

### Synaptic Inputs

In accordance with certain aspects of the present disclosure, normal synapses in the Kortex processor may comprise the following attributes:
i. Pre-synaptic neuron (FROM)
ii. Post-synaptic neuron (TO)
iii. Delay (between 1 and Max_Delay)
iv. Channel (between 0 and 3)

In an aspect of the present disclosure, dedicated hardware for “synaptic accumulations” may provide up to four independent input channels per neuron instance. The utility neurons may generally utilize two channels, with chan_{—}0 being “excitatory” and chan_{—}1 being “inhibitory”. The programmable neurons may generally utilize four configurable channels. Allowed synaptic delays can become configurable in two groups. For example, group A may comprise configurable channels 0 and 1, and group B may comprise configurable channels 2 and 3.

### Normalized Weights

Interface “signal levels” in the Kortex processor may be generally set to cover a unit span. Bit precision changes may shift the location of the least significant (LS) bit of fixed-point fields rather than the most significant (MS) bits. In an aspect, neural model “voltage” values may cover the range (−1,1). Classic voltage range models may need to be scaled in order to be within this particular range.

In an aspect, input filters may cover a range of (−1,1) for signed, and [0,1) for unsigned. Gain from input filters to (U,V) values may be configurable. In an aspect, synaptic input channel accumulators may cover the range [0,1). Saturation level for these accumulators may need to be considered. In an aspect, all synaptic weights may be defined over the range [0,1). “PSP gain” levels may be configurable per synapse type. In general, computational overflows may result in saturation.

### Non-Plastic Synapse Classes

There can be two non-plastic synapse classes: Fixed_Weight_Synapse class and STP_Synapse (“short-term plastic” synapse). In an aspect, Fixed_Weight_Synapse class may provide fixed-weight PSP inputs. Parameters of the Fixed_Weight_Synapse class are:

| | | | |
|---|---|---|---|
| i. | channel | synaptic channel index | int range [0, 3] |
| ii. | delay | synaptic delay | int range [1, Max_Delay] |
| iii. | w | synaptic weight | float range [0, 1) |

In an aspect, STP_Synapse class may provide “short-term plastic” synapse, i.e., weight may depend on length of time since previous spike. Parameters of the STP_Synapse class are:

| | | | |
|---|---|---|---|
| i. | channel | synaptic channel index | int range [0, 3] |
| ii. | delay | synaptic delay | int range [1, Max_Delay] |
| iii. | weight | max synaptic weight | float range [0, 1) |
| iv. | time_const | recovery TC in tau | float >= 0 |

### Plastic Synapses

In accordance with certain aspects of the present disclosure, plastic synapses in the Kortex processor may have many dynamic state variables that can change in response to spiking activity. A large number of control parameters may be needed to control this response, and these can be implemented in hardware as shared tables. As happens with the programmable neurons, the total number of independently tuned plastic synapse classes may be limited by the hardware.

In an aspect of the present disclosure, state fields may comprise:

| | | | |
|---|---|---|---|
| i. | delay | synaptic delay | Range [0, Max_Delay] |
| ii. | w | synaptic weight | Range [0, 1) |
| iii. | sd | delta-w eligibility trace | Range (−1, 1) |
| iv. | r | plasticity resource | Range [0, 1) |
| v. | worthy | suicide prevention flag | boolean |
| vi. | alive | synapse enable flag | boolean |

### Plastic Synapse Parameters

In an aspect of the present disclosure, parameters (shared) that control plastic synapses may comprise:

| | | |
|---|---|---|
| i. | channel | (accumulator channel control) |
| ii. | dopamine_en, w_mix | (weight update control) |
| iii. | w_sob, psp_gain, psp_bias | (mapping W to PSP weights) |
| iv. | pn_disable | (mode bit for the paranoid) |
| v. | stdp_early_LUT | (timing based weight plasticity) |
| vi. | stdp_late_LUT | (timing based weight plasticity) |
| vii. | stdp_asymptote | (timing based weight plasticity) |
| viii. | pre_beta, post_beta | (homeostasis parameters) |
| ix. | | (delay plasticity parameters) |
| x. | | (resource model parameters) |
| xi. | | (synaptic suicide control) |

### Kortex HLND Files

In an aspect of the present disclosure, Kingpin file is “kortex.hlnd”. It may perform a “USE” on all other HLND files describing each build. These other files may comprise:

| | | |
|---|---|---|
| i. | kortex_globals | Constants describing Kortex shape |
| ii. | kortex_macros | Code macros utilized in multiple |
| | | places |
| iii. | kortex_modulators | “Global” neuromodulator |
| | | mechanisms |
| iv. | kortex_extrinsic_axon_class | “Repeater” neurons for input |
| | | bundles |
| v. | kortex_diag_neuron_class | Periodic, Poisson, SOI neuron |
| vi. | kortex_delay_neuron_class | SOI with fixed delay |
| vii. | kortex_srm_neuron_class | Kludged Spike Response Model |
| | | neuron |
| viii. | kortex_rp_params | Parameters for RP neurons |
| | | (obsolete) |
| ix. | kortex_rp_neuron_class | RP neuron model |
| x. | kortex_stdp_params | Plastic synapse parameters |
| | | (obsolete) |
| xi. | kortex_plastic_synapse | Plastic synapse model |
| xii. | kortex_fixed_synapse.hlnd | Fixed weight synapse model |
| xiii. | korted_sd_synapse.hlnd | Short Term Plastic synapse model |

File: kortex_globals.hlnd (a.k.a. kortex_constants.hlnd)

In an aspect of the present disclosure, this file may describe “shape” of the released hardware. It may comprise HW_Constants global required for “hc_hlnd” mode. It may be auto-generated from hardware VHDL (Very high-speed integrated circuit Hardware Description Language)/Jabble database. One mechanism can be a VHDL test-bench with specific print commands.

In an aspect, this file may comprise “KTX_*” constants utilized by the rest of the kortex HLND files. These constants should generally be viewed as “private” but are currently of global scope like everything else. In addition, these constants may describe: a number of plastic synapse types, a number of RP neuron types, STDP window size, a replay delay, a maximum synapse delay, a number of synapse input channels and their accumulator bit-width, and (nearly) all of the fixed-point bit ranges used in the HLND models.

File: kortex_macros.hlnd

In an aspect of the present disclosure, this file may provide one code macro to maintain “NSS” state. All neurons that toss spikes may use the NSS_UPDATE macro. According to certain aspects, state variables may be:

| | | |
|---|---|---|
| i. | Reward | accumulated dopamine reward since last replay |
| ii. | Decay | eligibility decay factor since last replay |
| iii. | Delta (future) | tau steps since last spike |
| iv. | SpikeRate (future) | long term average spike rate |

In an aspect, this file may provide two code macros to maintain Internal Read Access Memory (IRAM) input buffers. All neurons that have IRAM inputs may use the IRAM_UPDATE macro. This macro may maintain the circular buffers and “extracts” spike outputs.

In an aspect, state variables may represent circular buffers and some mode bits. Circular buffer depths can be different across different IRAM channels. In addition, all synapses that drive PSPs may use the IRAM_ACCUM macro.

File: kortex_modulators.hlnd

In an aspect of the present disclosure, this file may provide everything used to describe the shared computations performed on a per-Kortex or per-Superneuron basis. In an aspect, “hw_kortex_modulators” unit may describe Super-Neuron (SN) operations related to maintaining the hardware SN_MOD record. In an aspect, “Kortex” global may be used to publish modulator values that are made available to the neuron models. These may comprise: Dopamine, Norepinephrine (NorEpi), Acetylcholine (Ach), DecayRate and pn_disable mode, and Tau counters.

In a preferred aspect, an array of hw_kortex_modulators would be defined, one for each SN. In addition, the Kortex global values would be arrays. It should be noted that a better name for the “Kortex” global might be “SN”.

In an aspect, this file may instantiate one modulator unit as “Kortex_Modulators”. Further, it may define neuromodulator control synapses that may be connected from any sort of spiking neuron to the modulator control units. In an aspect, hw_reward_synapse may change dopamine levels, and hw_norepi_synapse may change norepinephrine levels.

### STDP Updates to Plastic Synaptic State (PSST)

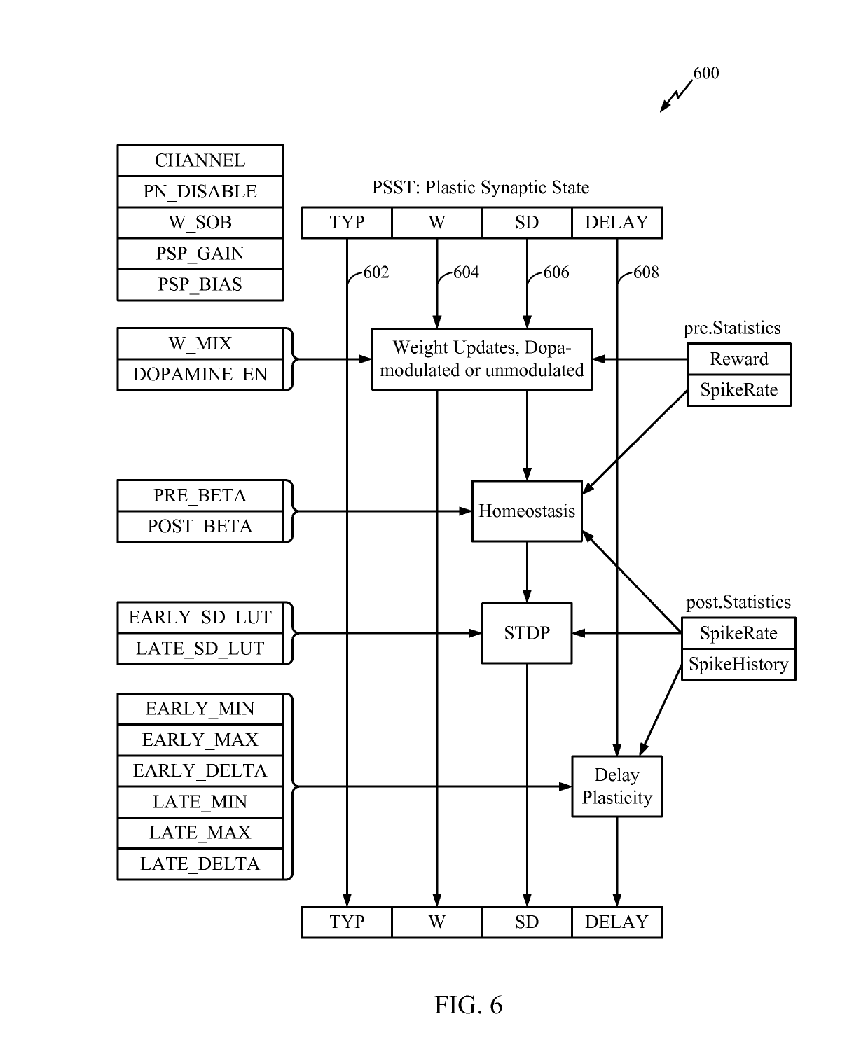

FIG. 6 illustrates an example diagram 600 of STDP updates to PSST, in accordance with certain aspects of the present disclosure. In an aspect, PSST may be updated during “spike replay” processing. As illustrated by flow 602 in FIG. 6, type (TYP) field of PSST may not be modified. As illustrated by flow 604 in FIG. 6, weight field (W) may be updated, dopamine-modulated or un-modulated.

As illustrated by flow 606 in FIG. 6, delta-w eligibility trace (SD) may be updated, dopamine-modulated or un-modulated. Further, homeostasis and STDP may be applied. In an aspect of the present disclosure, all weight changes may first happen to “SD” and are then propagated to “W”. In an aspect, the resource model may modify method for changing SD values. According to certain aspects, as illustrated by flow 608 in FIG. 6, delay plasticity may be applied independently to a DELAY field of PSST.

### Utility Neuron Models

According to certain aspects of the present disclosure, there may be several utility neuron models, such as Spike-On-Input (SOI) neuron model, Periodic neuron model, Bernoulli neuron model, and Delay neuron model. In an aspect, in the case of SOI neuron model, artificial neurons may spike when input channel 0>input channel 1. There are no specific parameters for this neuron model.

In another aspect, in the case of Periodic neuron model, artificial neurons may produce spikes on a periodic basis. The specific parameters may be PERIOD and PHASE, and there are no input channels.

In yet another aspect, in the case of Bernoulli neuron model, artificial neurons may produce spikes randomly with a given probability. One specific parameter may be PROBABILITY, and there are no input channels. In yet another aspect, in the case of Delay neuron model, artificial neurons may produce spikes some delayed time after (chan0>chan1) inputs. One specific parameter may be DELAY.

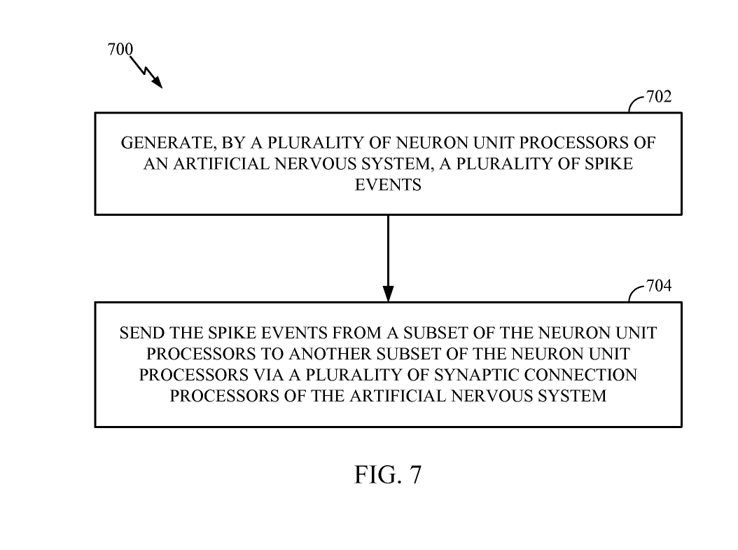

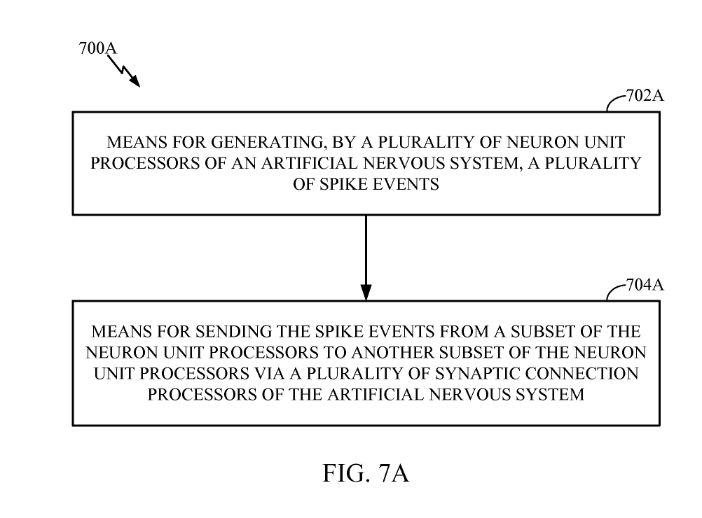

FIG. 7 is a flow diagram of example operations 700 for operating an artificial nervous system with a plurality of artificial neurons in accordance with certain aspects of the present disclosure. The operations 700 may be performed in hardware (e.g., by one or more neural processing units, such as a neuromorphic processor), in software, or in firmware. The artificial nervous system may be modeled on any of various biological or imaginary nervous systems, such as a visual nervous system, an auditory nervous system, the hippocampus, etc.

The operations 700 may begin, at 702, by generating, by a plurality of neuron unit processors of the artificial nervous system, a plurality of spike events. At 704, the spike events may be sent from a subset of the neuron unit processors to another subset of the neuron unit processors via a plurality of synaptic connection processors of the artificial nervous system.

In an aspect, the spike events may be converted, by the synaptic connection processors, into inputs to the neuron unit processors or into post-synaptic potential (PSP) weights associated with synaptic instances of the synaptic connection processors. According to certain aspects, the plurality of spike events may comprise intrinsic spike events and extrinsic spike events. In an aspect, inputs from the synaptic connection processors and the extrinsic spike events may be accepted at the neuron unit processors.

According to certain aspects, groups of synapses of the artificial nervous system driven by spiking of one neuron unit processor of the plurality of neuron unit processors may be processed simultaneously. In an aspect, an access to a memory subsystem of the artificial nervous system may be gained for the groups of synapses. In an aspect, by accessing the memory subsystem, reading, updating and writing-back of synaptic values associated with the groups of synapses may be supported. According to certain aspects, updates associated with artificial neurons or the synaptic events may be processed, by the neuron unit processors and the synaptic connection processors, with a throughput of one update/event per clock cycle.

According to certain aspects, the neuron unit processors may be programmable, wherein each individual instance of an artificial neuron associated with each of the neuron unit processors may comprise its own dedicated instruction and a state memory word using a specific number of bits. In an aspect, the specific number of bits may be partitioned between a fixed number of instruction bits for the dedicated instruction and state bits of the state memory word variable over time associated with a state of the artificial neuron. In an aspect, that neuron unit processor may be programmed independently of other of the neuron unit processors. In an aspect, some of the specific number of bits may be used as a pointer into shared table values of a memory subsystem of the artificial nervous system, wherein the table values may be shared across multiple of the neuron unit processors.

According to certain aspects, the synaptic connection processors may be programmable, wherein each individual synaptic instance associated with each of the synaptic connection processors may comprise its own dedicated instruction and a state memory word using a specific number of bits. In an aspect, the specific number of bits may be partitioned between a fixed number of instruction bits for the dedicated instruction and state bits of the state memory word variable over time related to a state of that synaptic instance. In an aspect, some of the specific number of bits may be used as a pointer into shared table values of a memory subsystem of the artificial nervous system, wherein the table values are shared across multiple of the synaptic connection processors. According to certain aspects, control parameters and values may be provided, by using control blocks of the artificial nervous system, to the neuron unit processors and the synaptic connection processors.

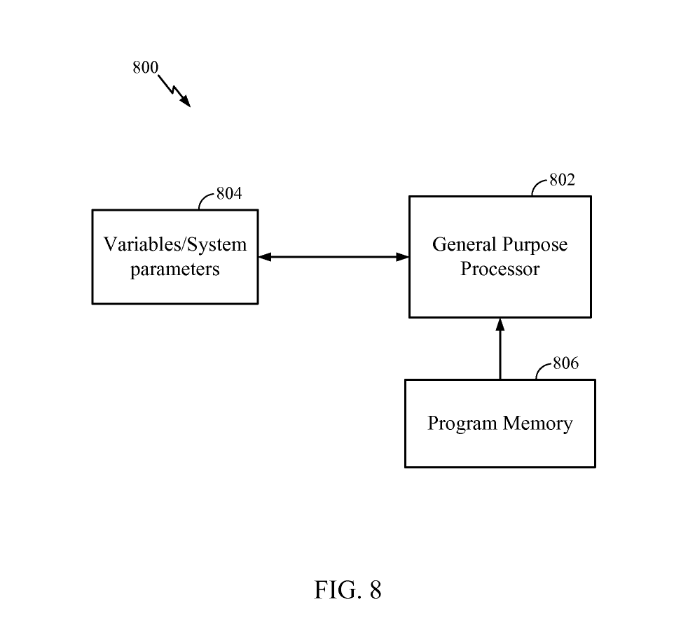

FIG. 8 illustrates an example block diagram 800 of the aforementioned method for operating an artificial nervous system with a plurality of artificial neurons using a general-purpose processor 802 in accordance with certain aspects of the present disclosure. Variables (neural signals), synaptic weights, and/or system parameters associated with a computational network (neural network) may be stored in a memory block 804, while instructions related executed at the general-purpose processor 802 may be loaded from a program memory 806. In an aspect of the present disclosure, the instructions loaded into the general-purpose processor 802 may comprise code for generating, by a plurality of neuron unit processors of the artificial nervous system, a plurality of spike events, and for sending the spike events from a subset of the neuron unit processors to another subset of the neuron unit processors via a plurality of synaptic connection processors of the artificial nervous system.

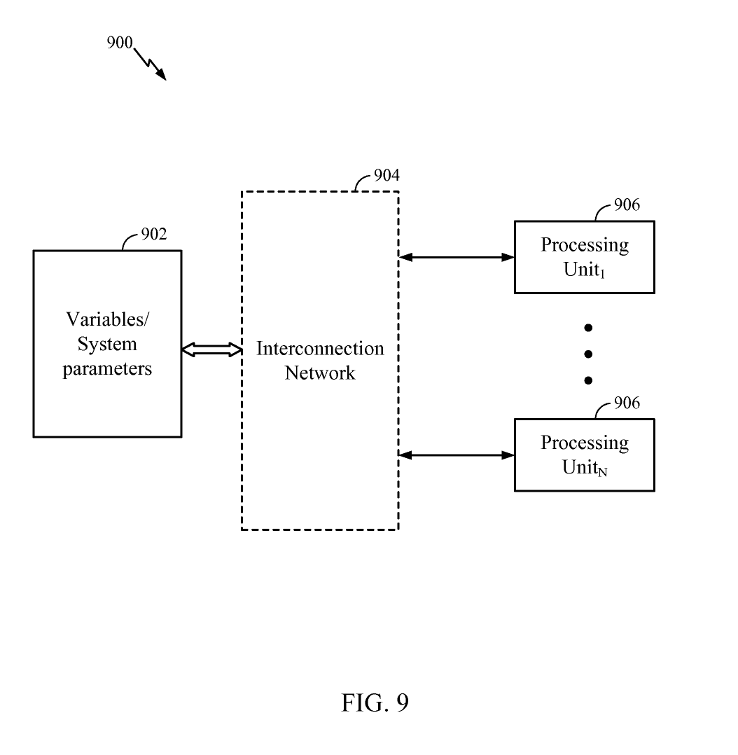

FIG. 9 illustrates an example block diagram 900 of the aforementioned method for operating an artificial nervous system with a plurality of artificial neurons where a memory 902 can be interfaced via an interconnection network 904 with individual (distributed) processing units (neural processors) 906 of a computational network (neural network) in accordance with certain aspects of the present disclosure. Variables (neural signals), synaptic weights, and/or system parameters associated with the computational network (neural network) may be stored in the memory 902, and may be loaded from the memory 902 via connection(s) of the interconnection network 904 into each processing unit (neural processor) 906. In an aspect of the present disclosure, the processing unit 906 may be configured to generate, by the neural processors of the artificial nervous system, a plurality of spike events, and to send the spike events from a subset of the neural processors to another subset of the neural processors via a plurality of synaptic connection processors of the artificial nervous system.

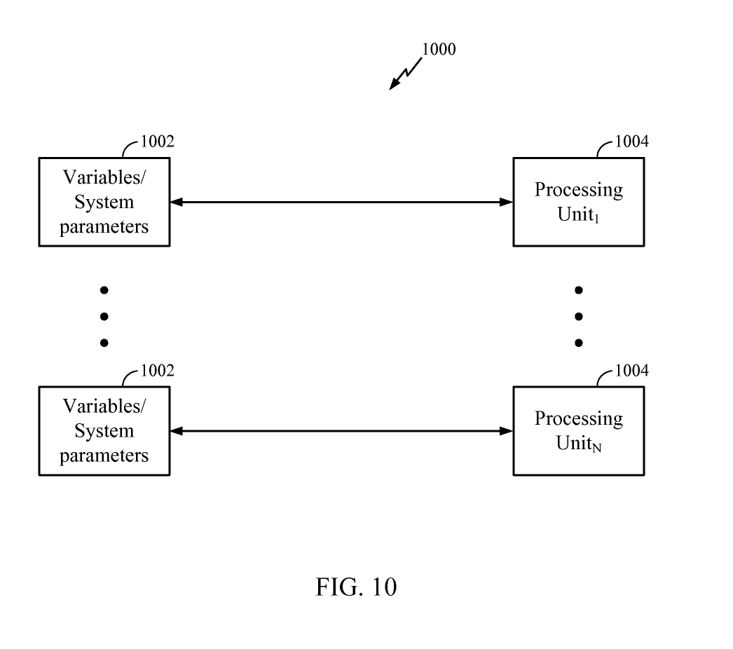

FIG. 10 illustrates an example block diagram 1000 of the aforementioned method for operating an artificial nervous system with a plurality of artificial neurons based on distributed weight memories 1002 and distributed processing units (neural processors) 1004 in accordance with certain aspects of the present disclosure. As illustrated in FIG. 10, one memory bank 1002 may be directly interfaced with one processing unit 1004 of a computational network (neural network), wherein that memory bank 1002 may store variables (neural signals), synaptic weights, and/or system parameters associated with that processing unit (neural processor) 1004. In an aspect of the present disclosure, the processing unit(s) 1004 may be configured to generate, by the neural processors of the artificial nervous system, a plurality of spike events, and to send the spike events from a subset of the neural processors to another subset of the neural processors via a plurality of synaptic connection processors of the artificial nervous system.

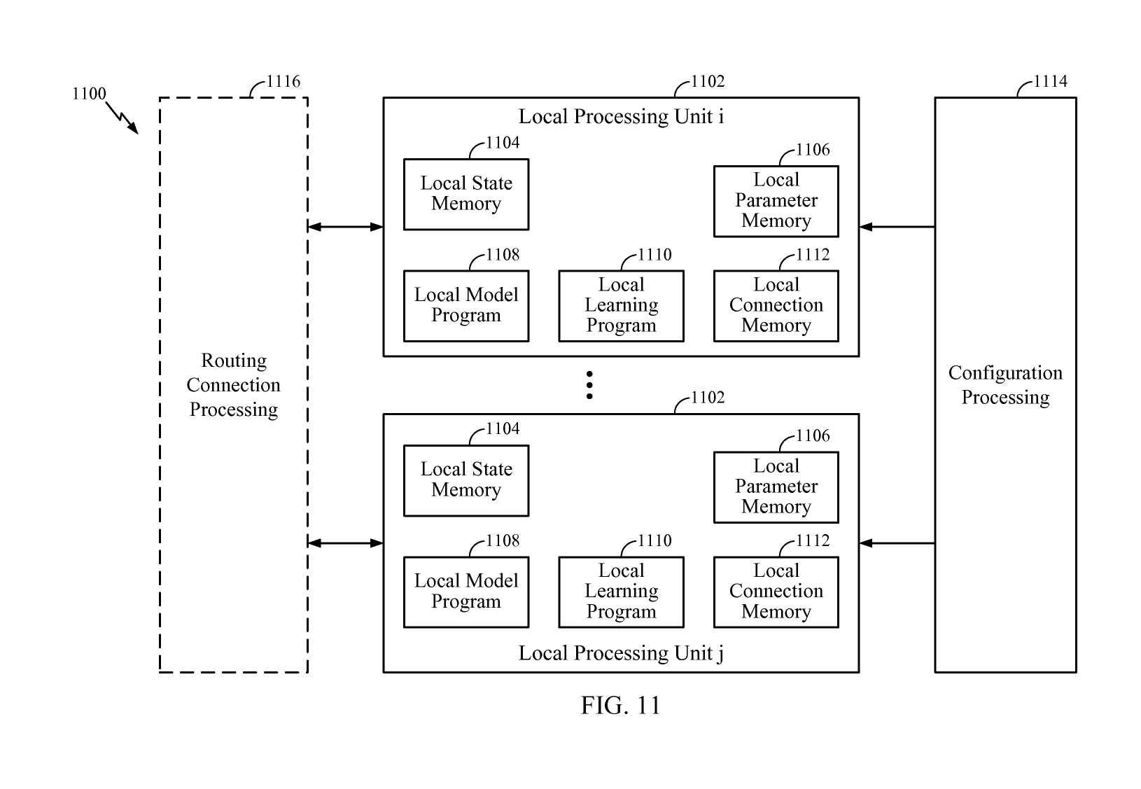

FIG. 11 illustrates an example implementation of a neural network 1100 in accordance with certain aspects of the present disclosure. As illustrated in FIG. 11, the neural network 1100 may comprise a plurality of local processing units 1102 that may perform various operations of methods described above. Each processing unit 1102 may comprise a local state memory 1104 and a local parameter memory 1106 that store parameters of the neural network. In addition, the processing unit 1102 may comprise a memory 1108 with a local (neuron) model program, a memory 1110 with a local learning program, and a local connection memory 1112. Furthermore, as illustrated in FIG. 11, each local processing unit 1102 may be interfaced with a unit 1114 for configuration processing that may provide configuration for local memories of the local processing unit, and with routing connection processing elements 1116 that provide routing between the local processing units 1102.

According to certain aspects of the present disclosure, each local processing unit 1102 may be configured to determine parameters of the neural network based upon desired one or more functional features of the neural network, and develop the one or more functional features towards the desired functional features as the determined parameters are further adapted, tuned and updated.

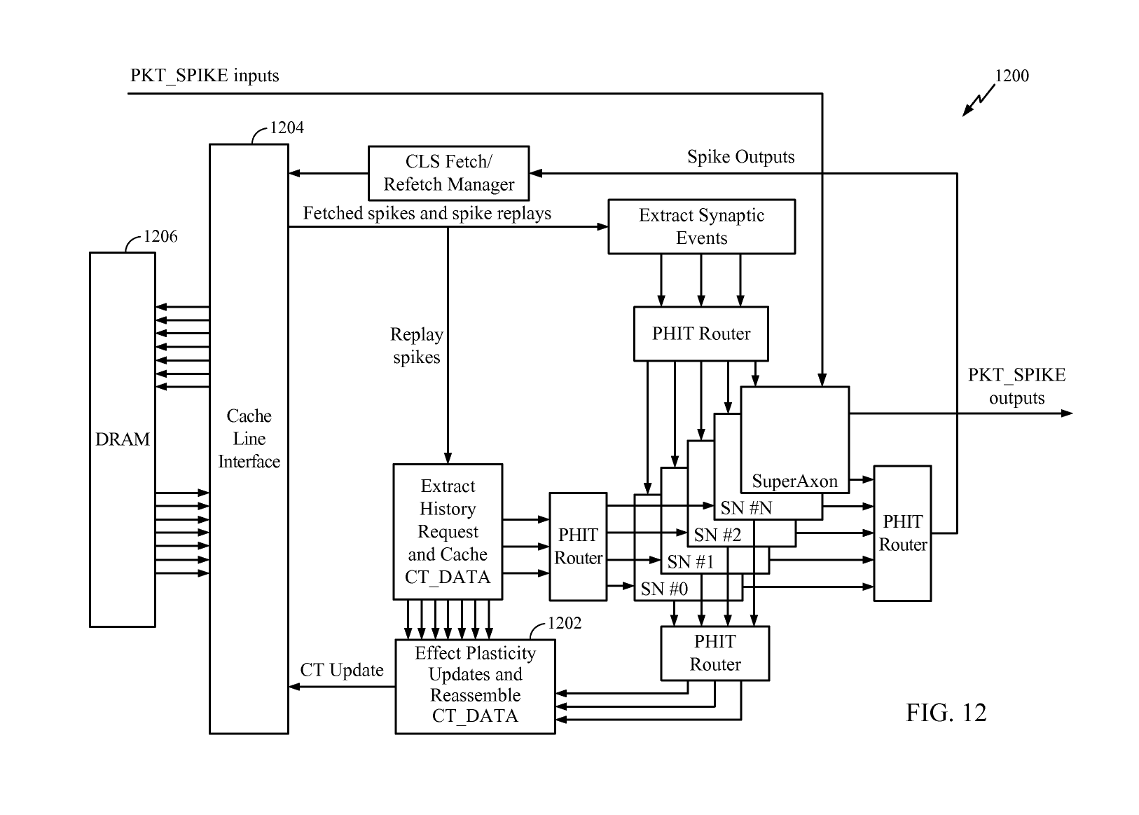

FIG. 12 is a block diagram 1200 of an example hardware implementation for an artificial nervous system, in accordance with certain aspects of the present disclosure. STDP updating, as described above, may occur in an Effect Plasticity Updates and Reassemble block 1202. For certain aspects, the updated synaptic weights may be stored, via a cache line interface 1204, in an off-chip memory (e.g., dynamic random access memory (DRAM) 1206).

In a typical artificial nervous system, there are many more synapses than artificial neurons, and for a large neural network, processing the synapse updates in an efficient manner is desired. The large number of synapses may suggest storing the synaptic weight and other parameters in a memory (e.g., DRAM 1206). When artificial neurons generate spikes in a so-called “super neuron (SN)”, the neurons may forward those spikes to the post-synaptic neurons through DRAM lookups to determine the post-synaptic neurons and corresponding neural weights. To enable fast and efficient lookup, the synapse ordering may be kept consecutively in memory based, for example, on fan-out from a neuron. Later when processing STDP updates in the Effect Plasticity Updates and Reassemble block 1202, efficiency may dictate processing the updates based on a forward fan-out given this memory layout since the DRAM or a large lookup table need not be searched to determine the reverse mapping for LTP updates. The approach shown in FIG. 12 facilitates this. The Effect Plasticity Updates and Reassemble block 1202 may query the super neurons in an effort to obtain the pre- and post-synaptic spike times, again reducing the amount of state memory involved.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various operations may be performed by one or more of the various processors shown in FIGS. 8-12. Generally, where there are operations illustrated in figures, those operations may have corresponding counterpart means-plus-function components with similar numbering. For example, operations 700 illustrated in FIG. 7 correspond to means 700A illustrated in FIG. 7A.

For example, means for displaying may include a display (e.g., a monitor, flat screen, touch screen, and the like), a printer, or any other suitable means for outputting data for visual depiction (e.g., a table, chart, or graph). Means for processing, means for receiving, means for tracking, means for adjusting, means for updating, or means for determining may comprise a processing system, which may include one or more processors or processing units. Means for sensing may include a sensor. Means for storing may include a memory or any other suitable storage device (e.g., RAM), which may be accessed by the processing system.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for operating an artificial nervous system, comprising:
generating, by a plurality of neuron unit processors of the artificial nervous system, a plurality of spike events; and
sending the spike events from a subset of the neuron unit processors to another subset of the neuron unit processors via a plurality of synaptic connection processors of the artificial nervous system.

2. The method of claim 1, further comprising:
converting, by the synaptic connection processors, the spike events into inputs to the neuron unit processors or into post-synaptic potential (PSP) weights associated with synaptic instances of the synaptic connection processors.

3. The method of claim 1, wherein the plurality of spike events comprises intrinsic spike events and extrinsic spike events.

4. The method of claim 3, further comprising:
accepting, at the neuron unit processors, inputs from the synaptic connection processors and the extrinsic spike events.

5. The method of claim 1, further comprising:
processing simultaneously groups of synapses of the artificial nervous system driven by spiking of one neuron unit processor of the plurality of neuron unit processors.

6. The method of claim 5, further comprising:
gaining access to a memory subsystem of the artificial nervous system for the groups of synapses.

7. The method of claim 6, further comprising:
supporting, by accessing the memory subsystem, reading, updating and writing-back of synaptic values associated with the groups of synapses.

8. The method of claim 1, further comprising:
processing, by the neuron unit processors and the synaptic connection processors, updates associated with artificial neurons or the synaptic events at a throughput of one update/event per clock cycle.

9. The method of claim 1, further comprising:
programming the neuron unit processors, wherein each individual instance of an artificial neuron associated with each of the neuron unit processors comprises its own dedicated instruction and a state memory word using a specific number of bits.

10. The method of claim 9, further comprising:
partitioning the specific number of bits between a fixed number of instruction bits for the dedicated instruction and state bits of the state memory word variable over time associated with a state of the artificial neuron.

11. The method of claim 9, further comprising:
programming that neuron unit processor independently of other of the neuron unit processors.

12. The method of claim 9, further comprising:
using some of the specific number of bits as a pointer into shared table values of a memory subsystem of the artificial nervous system, wherein the table values are shared across multiple of the neuron unit processors.

13. The method of claim 1, further comprising:
programming the synaptic connection processors, wherein each individual synaptic instance associated with each of the synaptic connection processors comprises its own dedicated instruction and a state memory word using a specific number of bits.

14. The method of claim 13, further comprising:
partitioning the specific number of bits between a fixed number of instruction bits for the dedicated instruction and state bits of the state memory word variable over time related to a state of that synaptic instance.

15. The method of claim 13, further comprising:
using some of the specific number of bits as a pointer into shared table values of a memory subsystem of the artificial nervous system, wherein the table values are shared across multiple of the synaptic connection processors.

16. The method of claim 1, further comprising:
providing, by using control blocks of the artificial nervous system, control parameters and values to the neuron unit processors and the synaptic connection processors.

17. An apparatus for operating an artificial nervous system, comprising:
a plurality of neuron unit processors of the artificial nervous system configured to generate a plurality of spike events; and
a first circuit configured to send the spike events from a subset of the neuron unit processors to another subset of the neuron unit processors via a plurality of synaptic connection processors of the artificial nervous system.

18. The apparatus of claim 17, further comprising:
synaptic connection processors configured to convert the spike events into inputs to the neuron unit processors or into post-synaptic potential (PSP) weights associated with synaptic instances of the synaptic connection processors.

19. The apparatus of claim 17, wherein the plurality of spike events comprises intrinsic spike events and extrinsic spike events.

20. The apparatus of claim 19, wherein the neuron unit processors are also configured to:
accept inputs from the synaptic connection processors and the extrinsic spike events.

21. The apparatus of claim 17, further comprising:
a second circuit configured to process simultaneously groups of synapses of the artificial nervous system driven by spiking of one neuron unit processor of the plurality of neuron unit processors.

22. The apparatus of claim 21, further comprising:
a third circuit configured to gain access to a memory subsystem of the artificial nervous system for the groups of synapses.

23. The apparatus of claim 22, wherein the third circuit is also configured to:
support, by accessing the memory subsystem, reading, updating and writing-back of synaptic values associated with the groups of synapses.

24. The apparatus of claim 17, wherein the neuron unit processors and the synaptic connection processors are also configured to:
process updates associated with artificial neurons or the synaptic events at a throughput of one update/event per clock cycle.

25. The apparatus of claim 17, further comprising:
a second circuit configured to program the neuron unit processors, wherein each individual instance of an artificial neuron associated with each of the neuron unit processors comprises its own dedicated instruction and a state memory word using a specific number of bits.

26. The apparatus of claim 25, wherein the second circuit is also configured to:
partition the specific number of bits between a fixed number of instruction bits for the dedicated instruction and state bits of the state memory word variable over time associated with a state of the artificial neuron.

27. The apparatus of claim 25, wherein the second circuit is also configured to:
program that neuron unit processor independently of other of the neuron unit processors.

28. The apparatus of claim 25, wherein the second circuit is also configured to:
use some of the specific number of bits as a pointer into shared table values of a memory subsystem of the artificial nervous system, wherein the table values are shared across multiple of the neuron unit processors.

29. The apparatus of claim 17, further comprising:
a second circuit configured to program the synaptic connection processors, wherein each individual synaptic instance associated with each of the synaptic connection processors comprises its own dedicated instruction and a state memory word using a specific number of bits.

30. The apparatus of claim 29, wherein the second circuit is also configured to:
partition the specific number of bits between a fixed number of instruction bits for the dedicated instruction and state bits of the state memory word variable over time related to a state of that synaptic instance.

31. The apparatus of claim 29, wherein the second circuit is also configured to:
use some of the specific number of bits as a pointer into shared table values of a memory subsystem of the artificial nervous system, wherein the table values are shared across multiple of the synaptic connection processors.

32. The apparatus of claim 17, further comprising:
control blocks of the artificial nervous system configured to provide control parameters and values to the neuron unit processors and the synaptic connection processors.

33. An apparatus for operating an artificial nervous system, comprising:
means for generating, by a plurality of neuron unit processors of the artificial nervous system, a plurality of spike events; and
means for sending the spike events from a subset of the neuron unit processors to another subset of the neuron unit processors via a plurality of synaptic connection processors of the artificial nervous system.

34. A computer-readable medium having instructions executable by a computer stored thereon for:
generating, by a plurality of neuron unit processors of an artificial nervous system, a plurality of spike events; and
sending the spike events from a subset of the neuron unit processors to another subset of the neuron unit processors via a plurality of synaptic connection processors of the artificial nervous system.
